(19) United States
(12) Patent Application Publication
(10) Pub. No.: US 2008/0286065 A1
(43) Pub. Date: Nov. 20, 2008

(54) Undercut Anchor

(76) Inventors: Marc Schaeffer, Horb-Bildechingen (DE); Oliver Hacker, Horb (DE)

Correspondence Address: MICHAEL J. STRIKER, 103 EAST NECK ROAD, HUNTINGTON, NY, 11743, US

(21) Appl. No.: 11/572,692

(22) PCT Filed: Jun. 14, 2005
(86) PCT No.: PCT/EP05/06355

§ 371 Date: Jan. 25, 2007

(30) Foreign Application Priority Data
Sep. 18, 2004 (DE) 10 2004 045 439.6

(51) Int. Cl. F16B 13/08

(52) U.S. Cl. 411/54

(57) ABSTRACT

The invention relates to an undercut anchor (10) comprising an anchor shaft (12) and a non-circular, for example triangular, anchor head (16). Said undercut anchor (10) is to be anchored in a borehole which is produced by ultrasound boring, has a cross-section matching that of the anchor head (16), and an undercut at the bottom thereof, that engages at the rear of the anchor head (16) following a rotation of 60°. A rotation-preventing element (18) is used to ensure that the anchor is rotationally fixed, said element having a cross-section matching the anchor head (16), and a recess (22) arranged on a front side thereof facing the anchor head (16) and corresponding thereto (16). When the anchor head (16) engages with the undercut of the borehole following the rotation, the rotation-preventing element (18) slides towards the anchor head (16) with the recess (22) thereof, holding the anchor head (16) in the borehole in a rotationally fixed manner, and thus securing the anchoring.

The invention relates to an undercut anchor having the features of the preamble of claim 1.

The undercut anchor according to the invention is intended for anchoring in a non-circular drilled hole having an undercut. Such a drilled hole can be produced by ultrasonic drilling using a drilling tool which is not circular but instead has, for example, a triangular cross-section. For drilling, the drilling tool is excited so as to produce vibrations in the ultrasonic frequency range; it is not driven in rotation. When the drilling tool has a drilling head of non-circular cross-section on a shank, the drilling tool can be rotated at the end of the hole and, as a result, an undercut can be produced.

The problem of the invention is to propose an undercut anchor which can be anchored in a drilled hole of such a kind in interlocking manner.

In accordance with the invention, the problem is solved by the features of claim 1. The undercut anchor according to the invention has an anchor shank and an anchor head, the anchor head projecting out laterally beyond the anchor shank and having a non-circular shape. Preferably, the anchor head projects laterally beyond the anchor shank at one or more peripheral locations. The anchor head can be, for example, hammerhead-like or triangular. The undercut anchor can especially have the same geometry as the drilling tool; it is even possible for the undercut anchor to be used as the drilling tool. The anchor head of the undercut anchor according to the invention especially has the same cross-section as the drilled hole in which the undercut anchor is to be anchored. The undercut anchor is introduced into the drilled hole and, once the anchor head is located in the undercut of the drilled hole, is rotated so that the anchor head engages behind the undercut of the drilled hole. The undercut anchor according to the invention is anchored in the drilled hole in interlocking manner and with a large anchoring force. In order to fail, either the anchoring substrate or the undercut anchor must fail. Further advantages of the invention are anchoring that is free from expansion pressure and the possibility of making the undercut anchor in one piece without an expansion sleeve or the like.

In a development of the invention there is provided an anti-rotation part, the purpose of which is to hold the undercut anchor in the anchored position so that it cannot come out of engagement as a result of rotation. Limited rotational play in the drilled hole can be acceptable. The anti-rotation part is arranged in axially displaceable manner on the anchor shank of the undercut anchor. The anti-rotation part and the undercut anchor form an interlocking engagement coupling, which can—as a result of displacement of the anti-rotation part on the anchor shank—be so brought into engagement with the undercut anchor that relative rotation is not possible. When the anti-rotation part is in engagement with the undercut anchor such that relative rotation is not possible, the anti-rotation part projects out laterally from the anchor shank at one or preferably more different peripheral locations to the anchor head, as a result of which the anti-rotation part is secured against rotation in the non-circular drilled hole and in turn secures the anchor head against rotation so that the anchor head remains in position engaging behind the undercut.

As the interlocking engagement coupling there come into consideration, for example, an axially parallel or radial pin engaging in a hole or groove, a tongue-and-groove connection and a polygonal or multi-sided profile. In an embodiment of the invention there is provided, at that end face of the anti-rotation part which faces the anchor head, a recess which corresponds to the anchor head. For engagement with the undercut anchor such that relative rotation is not possible, the anti-rotation part is pushed up to the anchor head so that the anchor head fits into the recess in the anti-rotation part, where it is held so that relative rotation is not possible. This embodiment of the invention is similar to a jaw coupling. It makes it possible for the undercut anchor to be secured against rotation in a drilled hole in simple and effective manner.

In a preferred embodiment of the invention, the anchor head and the anti-rotation part have matching cross-sections. On being introduced into a drilled hole, the anchor head and the anti-rotation part are so rotated that they are in register with one another. In the drilled hole, the anchor head is rotated into the position engaging behind the undercut whereas the anti-rotation part remains unrotated in the drilled hole. The anti-rotation part is pushed up to the anchor head and secures it in the rotated position of engagement behind the undercut.

The invention will be explained in greater detail hereinbelow by means of an exemplary embodiment shown in the drawings, in which:

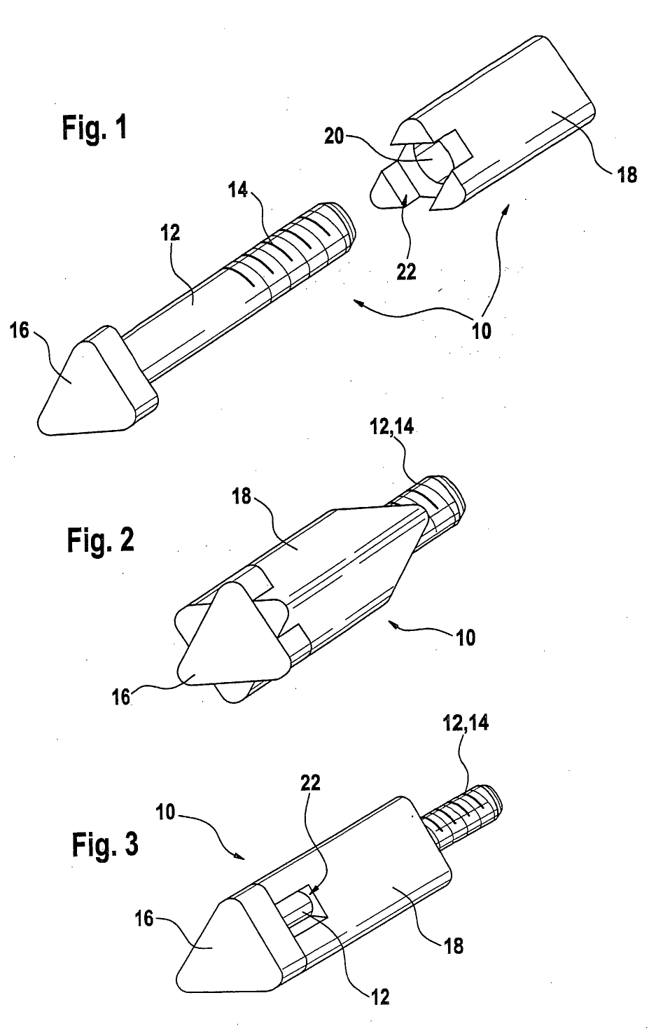

FIG. 1 shows an undercut anchor according to the invention in an exploded perspective view;

FIGS. 2 and 3 show the undercut anchor of FIG. 1 in the assembled state in a perspective view in two different positions;

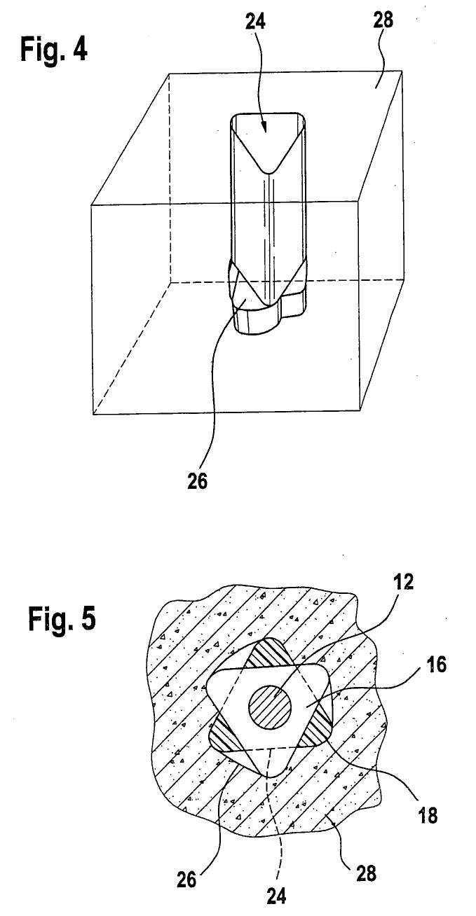

FIG. 4 shows a drilled hole for anchoring the undercut anchor of FIGS. 1 and 2; and

FIG. 5 is a cross-section through the drilled hole of FIG. 4 at the level of an undercut.

The undercut anchor 10 shown in FIG. 1 has an anchor shank 12 having a thread 14 at one end and an anchor head 16 at the other end. The anchor head 16 is in the shape of a triangular plate with rounded corners and projects out laterally beyond the anchor shank 12. The anchor shank 12 together with the anchor head 16 is made of, for example, steel, where appropriate a stainless steel.

The undercut anchor 10 furthermore comprises an anti-rotation part 18. The anti-rotation part 18 is prismatic; it has a triangular cross-section with rounded corners which matches the anchor head 16. The anti-rotation part 18 has an axial through-hole 20 by means of which, in the assembled state of the undercut anchor 10, it is arranged so as to be rotatable and displaceable on the anchor shank 12. On its end face facing the anchor head 16, the anti-rotation part 18 has a recess 22 corresponding to the anchor head 16. As can be seen in FIG. 2, the anchor head 16 fits into the recess 22 when the anchor head 16 is rotated through 60° relative to the anti-rotation part 18. The corners of the triangular anchor head 16 project out laterally beyond the outer surfaces of the anti-rotation part 18. If the anchor head 16 is pushed out from the recess 22, the anchor head 16 can be rotated relative to the anti-rotation part 18 so that the anchor head 16 is—seen in the axial direction—in register with the anti-rotation part 18 (FIG. 3). As a result of the recess 22, the anti-rotation part 18 and the anchor head 16 form a kind of jaw coupling, that is to say an interlocking engagement coupling. The anchor head 16 is secured against rotation in the recess 22 of the anti-rotation part 18 when it is located in the recess 22. When the anchor head 16 is located outside the recess 22 it is rotatable relative to the anti-rotation part 18.

The undercut anchor 10 is intended for anchoring in a drilled hole 24 of triangular cross-section having undercuts 26, as shown in FIG. 4. FIG. 4 depicts the anchoring substrate 28 in transparent form in order to show the drilled hole 24. The cross-section of the drilled hole 24 matches the cross-section of the anchor head 16, that is to say the drilled hole 24 has a triangular cross-section with rounded corners. The anchoring substrate 28 is, for example, stone or concrete. The drilled hole 24 is made by ultrasonic drilling. A drilling tool (not shown) has a shank having a drilling head, the geometry of the drilling head matching the geometry of the anchor head 16. The shank 12 together with the anchor head 16 can possibly be used as the drilling tool. For the purpose of drilling, the drilling tool (not shown) is excited so as to produce vibrations in the ultrasonic frequency range and is introduced into the anchoring substrate 28 without being rotated. After reaching the intended drilled hole depth, the drilling tool is rotated through 60°, as a result of which the undercuts 26 are produced. The undercuts 26 can be seen in FIG. 5; the drilled hole 24 is indicated by broken lines and is in register with the anti-rotation part 18. The drilling tool is then rotated back again, without being excited to produce vibrations, and is taken out of the drilled hole 24. The undercut anchor 10 is introduced into the drilled hole 24, for which the anchor head 16 is, as shown in FIG. 3, oriented in register with the anti-rotation part 18. Once the anchor head 16 has come up against the bottom of the drilled hole, it is rotated by the shank 12 projecting out of the drilled hole 24 until it comes up against a stop. The corners of the triangular anchor head 16 engage behind the undercuts 26 of the drilled hole 24; the undercut anchor 10 is anchored in the drilled hole 24. The anti-rotation part 18 is, by virtue of its cross-section matching the cross-section of the drilled hole 24, secured against rotation in the drilled hole 24 and does not rotate together with the anchor head 16. After the anchor head 16 has been rotated, the anti-rotation part 18 is pushed deeper into the drilled hole 24 so that the recess 22 of the anti-rotation part 18 reaches the anchor head 16.

The anchor head 16 is secured against rotation in the recess 22 of the anti-rotation part 18 and is no longer capable of rotation because the anti-rotation part 18 is secured against rotation in the drilled hole 24. The anchor head 16 is, as a result, secured against rotation and cannot come out of engagement with the undercuts 26 of the drilled hole 24 unless the anti-rotation part 18 has first been pulled back. The undercut anchor 10 is secured against disengagement.

1. Undercut anchor having an anchor shank and an anchor head which projects out laterally beyond the anchor shank, characterised in that the anchor head (16) is not circular.

2. Undercut anchor according to claim 1, characterised in that the anchor head (16) projects laterally beyond the anchor shank (12) at one or more peripheral locations.

3. Undercut anchor according to claim 1, characterised in that the undercut anchor (10) comprises an anti-rotation part (18).

4. Undercut anchor according to claim 3, characterised in that the anti-rotation part (18) is arranged so as to be axially displaceable on the anchor shank (12); in that the anti-rotation part (18), together with the undercut anchor (10), forms an interlocking engagement coupling which, as a result of displacement of the anti-rotation part (18) on the anchor shank (12), is arranged to be so brought into engagement with the undercut anchor (10) that relative rotation is not possible: and in that the anti-rotation part (18), when in engagement with the undercut anchor (10) such that relative rotation is not possible, projects out laterally from the anchor shank (12) at a different peripheral location to the anchor head (16).

5. Undercut anchor according to claim 4, characterised in that the anti-rotation part (18) has, at its end face facing the anchor head (16), a recess which corresponds to the anchor head (16), by virtue of which recess the anti-rotation part (18) can be pushed up to the anchor head (16) for engagement such that relative rotation is not possible.

6. Undercut anchor according to claim 4, characterised in that the anti-rotation part (18) and the anchor head (16) have matching, non-circular cross-sections, which are offset from one another when the anti-rotation part (18) and the undercut anchor (10) are in engagement such that relative rotation is not possible.
